(19) United States
(12) Patent Application Publication
(10) Pub. No.: US 2003/0036476 A1
(43) Pub. Date: Feb. 20, 2003

(54) Shell catalysts, method for producing the same, and the use thereof

(76) Inventors: Heiko Arnold, Mannheim (DE); Cristina Freire Erdbrugger, Freinsheim (DE); Thomas Heidemann, Weinheim (DE); Gerald Meyer, Ludwigshafen (DE); Signe Unverricht, Mannheim (DE); Andrea Frenzel, Limburgerhof (DE); Joachim Wulff-Doring, Schifferstadt (DE); Andreas Ansmann, Wiesloch (DE)

Correspondence Address: KEIL & WEINKAUF, 1350 CONNECTICUT AVENUE, N.W., WASHINGTON, DC, 20036, US

(21) Appl. No.: 10/221,275

(22) PCT Filed: Mar. 23, 2001
(86) PCT No.: PCT/EP01/03376

(30) Foreign Application Priority Data
Mar. 28, 2000 (DE) 100-15-250.3

(51) Int. Cl. B01J 23/38; C10G 45/60; C10G 45/04

(52) U.S. Cl. 502/325; 502/344; 208/213; 208/254 H; 208/251 H

(57) ABSTRACT

In a coated catalyst having a core and at least one shell surrounding the core, the core is made up of an inert support material, the shell or shells is/are made up of a porous support substance, with the shell being attached physically to the core, and a catalytically active metal selected from the group consisting of the metals of the 10th and 11th groups of the Periodic Table of the Elements is present in finely divided form or a precursor of the catalytically active metal is present in uniformly distributed form in the shell or shells.

The coated catalyst of the present invention is suitable for the reduction of unsaturated hydrocarbons. Here, better selectivities than in the case of previously known coated catalysts can be achieved. A process for producing the coated catalyst is also described.

The present invention relates to a coated catalyst having a core and at least one shell surrounding the core, to a process for producing it and to the use of the coated catalyst.

The metal catalysts used for the hydrogenation of unsaturated hydrocarbons are usually applied to a homogeneous porous support, for example calcium carbonate or activated carbon. The catalyst is produced by impregnating the support with a solution of the metal salt. After drying, the metal salt is reduced by means of hydrogen and the catalyst is thereby activated. Such catalysts have a high reaction rate, although the selectivity of the hydrogenation is often not satisfactory. The cause of this is the structure of such catalysts. Impregnation of the support with the solution of a metal salt does not always achieve a uniform distribution of the active component in the porous support. In the present context, an activated component can be either the catalytically active metal itself or its precursor compound, e.g. a metal salt. The porous support thus has regions with a relatively high concentration of active component or regions with a low concentration of active component, relative to the average concentration of the active component over the volume of the total porous support. This leads to difficulties in carrying out the reaction, since the reaction conditions can vary over the volume of the support. A further difficulty is that the residence time of an individual molecule compared to other molecules in the porous support varies. This is caused by the different penetration depth or diffusion rate of the individual molecules.

A hydrogenation catalyst is thus required to display, firstly, a sufficient conversion rate and, secondly, a high selectivity. Furthermore, long operating periods between regenerations together with, particularly in the case of noble metal catalysts, simple reprocessability at the end of the life of the catalyst are required.

DE-A-27 15 094 describes a catalyst for the selective hydrogenation of highly unsaturated hydrocarbons. In these, palladium is applied to a particulate porous aluminum oxide support, with the palladium being distributed mainly in a region of the catalyst particles which is not more than 150 μm under the geometric surface of the particles. The support particles can consist entirely of aluminum oxide. However, it is also possible for the aluminum oxide to be present as a coating on another material. The aluminum oxide support is most advantageously the calcination product of a pseudoboehmite. The support is porous over its entire volume and, in the case of a multilayer structure, the constituents of the support are held together by chemical bonds which, for example in the case of the calcination of pseudoboehmite, are formed between the core and the shell. The palladium is preferably applied to the support by wet methods, by dipping the support into a solution of a palladium compound or spraying the solution onto the support. The palladium metal is set free by heating or by reduction with hydrogen. In the examples, aluminum oxide particles are sprayed with an aqueous solution of a palladium salt.

EP 0 075 314 describes bifunctional catalysts comprising γ-aluminum oxide and nickel(II) oxide and their production. The catalysts are used for cracking fuels by partial oxidation. Catalysts used are coated catalysts having an inactive core and catalytically active constituents present in the form of thin layers on the core. The inert compact core of the catalysts comprises α-aluminum oxide and/or mullite and/or fired ceramic material and/or magnesium oxide and/or magnesite. The shell of the catalyst comprises γ-aluminum oxide and nickel(II) oxide. It is produced by alternately spraying the inert support particles with a nickel salt solution and a powder comprising γ-aluminum oxide and nickel(II) oxide or aluminum oxide and having particle sizes of less than 100 μm. As an alternative, the inert support particles can also be sprayed with a suspension prepared from γ-aluminum oxide and nickel(II) oxide and a nickel salt solution. After application of the shell, the catalyst is ignited.

U.S. Pat. No. 4,255,253 describes a coated catalyst for reducing the sulfur, nitrogen or metal content of hydrocarbon fractions, as are obtained, for example, in petroleum processing. The coated catalyst comprises a support which is porous at least in some regions, has a diameter of at least 20 μm and is coated with a catalytically active material. This material comprises a catalytically active oxide component and a support material which can form a firm bond with the surface of the support. To produce the coated catalyst, the support is firstly moistened. The pulverulent catalytically active material is subsequently rolled onto the outer surface of the support by gently agitating the support in the powder. As an alternative, it is proposed that the moistened support be coated firstly with a support material and, after calcination, be impregnated with a solution of precursor compounds of the metal oxides.

DE 196 07 437 A1 discloses a process for producing supported metal catalysts having an egg-shell-like profile of the distribution of the active metal. For this purpose, organometallic compounds of metals such as Pd, Ni, Co, Mo, Cu, Pt, Fe, Ag, Ir, Pb, Pi, Sm, V, Zn, etc., are dissolved in a pure organic solvent. The metal compounds are transferred to the surface of a support by wet impregnation and/or a spraying process. Here, the concentration profile of the metal and the metal loading can be controlled accurately by choice of suitable solvents and/or processing conditions. The support material of the catalyst is homogeneous, i.e. no further layers of support material are applied to the outside of the support body.

EP 0 542 528 describes a process for hydroisomerizing waxes. A platinum-containing coated catalyst is used for the isomerization. To produce the catalyst, a layer of boehmite or pseudoboehmite is applied to a catalytically inert core, and the catalytically active material is introduced into this layer. During calcination, the boehmite/pseudoboehmite is transformed into γ-aluminum oxide and forms a chemical bond to the underlying core.

EP 0 547 756 A1 describes a coated catalyst whose coating comprises platinum on fluorinated aluminum oxide. To produce the catalyst, a slurry of catalytically active substances and boehmite or pseudoboehmite is applied to a core of inert, catalytically inactive material, for example α-aluminum oxide. The particles are subsequently heated to convert the boehmite/pseudoboehmite into γ-aluminum oxide, thus forming a chemical bond between the shell and the core.

WO 98/37967 describes a process for producing coated catalysts for the catalytic gas-phase oxidation of aromatic hydrocarbons. Here, a layer of catalytically active metal oxides is applied in the form of a shell to a core of inert material. As catalytically active constituent of the catalytically active composition, use is generally made of titanium dioxide in the form of its anatase modification together with vanadium pentoxide. Small amounts of many other oxidic compounds serving as promoters to influence the activity and selectivity of the catalyst can also be present. To produce the catalysts, a powder of the catalytically active composition is produced by spray drying a suspension of appropriate precursor compounds. This is then applied to shaped bodies in a coating drum with addition of a mixture of water and an organic solvent. The coated catalyst support is subsequently dried.

DE 29 09 671 describes a process for producing coated catalysts. The catalysts can be used for the oxidation of acrolein by oxygen to give acrylic acid. To produce the coated catalyst, a porous inert support which forms the core of the coated catalyst is firstly premoistened with water in an amount ranging from at least 0.1% of its weight to 95% of its water uptake capacity. Subsequently, the catalytically active material and water are applied continuously and physically separately from one another at a constant addition rate to the vigorously agitated support. The water content of the shell which forms is less than the maximum degree of saturation of the shell of the catalytically active material. The shell of the catalyst comprises molybdenum and vanadium together with further transition metals in oxidic form.

EP 0 714 700 A2 describes a process for producing a catalyst comprising a core and a catalytically active oxide composition applied to the surface of the core. For this purpose, a support body which forms the core of the coated catalyst is firstly moistened with an aqueous solution of an organic substance having a boiling point at atmospheric pressure of above 100° C. as liquid to provide adhesion and a layer of active oxide composition is then made to adhere to the surface of the moistened support body by bringing it into contact with a dry, finely divided active oxide composition. The liquid to provide adhesion is subsequently removed from the moistened support body which has been coated with active oxide composition. The catalytically active oxide composition comprises, as metals, molybdenum and vanadium together with further metals.

It is an object of the present invention to provide a catalyst for the gas-phase hydrogenation of unsaturated hydrocarbons, which catalyst displays increased selectivity.

We have found that this object is achieved by a coated catalyst having a core and at least one shell surrounding the core, wherein the core is made up of an inert support material, the shell or shells is/are made up of a porous support substance, with the shell being attached physically to the core, and at least one catalytically active metal selected from the group consisting of the metals of the 10th and 11th groups of the Periodic Table of the Elements, or a precursor of the catalytically active metal, is present in uniformly distributed, finely divided form in the shell or shells.

The coated catalyst of the present invention made it possible to achieve a significant increase in the selectivity of hydrogenations in the gas phase. The shell enables defined and uniform reaction conditions to be created. Since the core contains no active component, a catalytic reaction takes place only in the shell of the coated catalyst, whose thickness and composition can be selected in a defined way. The diffusion paths of the reactants in the shell are short and approximately equal for all molecules. Between the core and this surrounding shell there is only a physical connection which is, for example, achieved by shrinkage of the shell. No chemical bonds are formed between core and shell. However, the adhesion between the individual particles and between shell and core is sufficient to ensure a stable structure of the catalyst particles. After the coated catalyst has reached the end of its life, it can easily be worked up by mechanical separation of shell and core.

The catalytically active metal can either be present directly in finely divided form in the shell or it is formed under hydrogenation conditions from a precursor of the catalytically active metal which has been, for example, distributed uniformly in the shell by spraying-on of a solution.

Possible materials for the core are, in particular, aluminum oxide, silicon dioxide, silicates such as clay, kaolin, steatite, pumice, aluminum silicate and magnesium silicate, silicon carbide, zirconium dioxide and thorium dioxide. The core can be made up of a porous support material. However, the total volume of the pores relative to the volume of the support material is preferably less than 1% by volume. In principle, any geometries of the core are possible. However, preference is given to using spheres or cylinders, in particular hollow cylinders, as cores. Their longitudinal dimension is generally from 1 to 10 mm.

If cylinders are used as core, their length is preferably from 2 to 10 mm and their external diameter is preferably from 4 to 10 mm. In the case of rings, the wall thickness is, in addition, usually from 1 to 4 mm. Particularly preferred annular cores have a length of from 3 to 6 mm, an external diameter of from 4 to 8 mm and a wall thickness of from 1 to 2 mm. Very particular preference is given to rings having a geometry of 7 mm×3 mm×4 mm (external diameter×length×internal diameter).

The surface of the core is advantageously rough, since an increased surface roughness generally gives increased adhesion of the applied shell. The surface roughness R_{z} of the core is generally in the range from 40 to 200 μm, preferably from 40 to 100 μm (determined in accordance with DIN 4768 part 1 using a “Hommel tester for DIN-ISO surface measurements” from Hommelwerke). The support substance applied to the core has a high porosity. As materials for the shell, it is possible to use the same materials as for the core. Particular preference is given to aluminum oxide, zirconium dioxide, titanium dioxide and silicon dioxide. The support substance of the shell is generally chemically inert, i.e. it essentially does not participate in the gas-phase hydrogenation which is catalyzed by the coated catalysts of the present invention. Depending on the reaction which is catalyzed, it is also possible to use acidic or basic support substances. The noble metal catalysts are incorporated in finely divided form in the shell.

The metals can also be present in the shell of the coated catalyst in the form of a precursor in uniformly distributed form. These precursors can be converted into the active form of the pure metals under the hydrogenation conditions of the catalyzed reaction. Suitable precursors of the catalytic metals are the corresponding metal oxides or water-soluble metal salts. Preference is given to using the chlorides, nitrates, C₁-C₁₀ carboxylates, carbonates, hydrogencarbonates, sulfates, hydrogensulfates or phosphates. The advantage of the water-solubility of the salts is that the compounds in the liquid phase can be uniformly introduced into the shell material very simply by impregnation or spraying. In principle, it is also possible to use water-insoluble compounds which are firstly mixed intimately with the support substance forming the shell prior to producing the shell catalyst.

A plurality of superposed shells can be provided around the core of the coated catalyst. The shells can comprise different catalytically active metals. The concentration of the catalytically active metal can also be different in the various shells. In this way, a further improvement in the selectivity of the hydrogenation reaction can be achieved.

The thickness of the shell applied according to the present invention to the core is advantageously from 1 to 1000 μm. Preference is given, particularly in the case of annular cores, to shell thicknesses in the range from 10 to 500 μm, in particular from 50 to 300 μm.

According to the present invention, the coated catalysts can be produced by a process comprising the steps:

a) providing a support comprising an inert support material to form the core of the coated catalyst;

b) sprinkling the support with an oxidic, pulverulent support substance while keeping the support in motion, to form a shell;

c) spraying the support with a binder comprising an aqueous solution of an organic compound which has a boiling point at atmospheric pressure of more than 100° C.;

d) introducing a catalytically active metal selected from the group consisting of the metals of the 10th and 11th groups of the Periodic Table of the Elements or a precursor compound of these metals;

e) evaporating volatile constituents;

f) if appropriate, activating the precursor compound of the metals, where steps b), c) and d) can be carried out simultaneously or in succession in any order and can also, if desired, be carried out two or more times.

Coating is generally carried out by placing the cores to be coated in a preferably inclined (the angle of inclination is generally from 30 to 90°) rotating container (e.g. rotating pan or coating drum). The rotating container conveys the, in particular spherical or cylindrical, particularly preferably hollow-cylindrical, cores along under two successive metering devices which are a particular distance apart. The first of the two metering devices advantageously corresponds to a nozzle by means of which the cores rolling in the rotating pan are sprayed with the liquid binder to be used according to the present invention and are moistened in a controlled fashion. The second metering device is located outside the atomization cone of the liquid binder sprayed in and serves to feed in the finely divided support substance forming the shell (e.g. via a vibrating chute). The cores which have been moistened in a controlled fashion collect the introduced support substance which is, by means of the rolling motion, compacted on the outer surface of the cylindrical or spherical core to form a coherent shell.

If required, the core which has been base-coated in this way again runs past underneath the spray nozzle during the subsequent rotation and is thereby moistened in a controlled fashion so that it can take up a further layer of finely divided support substance during the course of a further movement, and so forth (intermediate drying is generally not necessary). In this case, the core with the previously applied shells forms the support for the shell to be applied.

In the production of the coated catalyst, a thin shell is advantageously formed first by sprinkling the core with a small amount of dry oxidic pulverulent support substance. This is subsequently fixed by spraying with binder. The shell is subsequently built up to the desired thickness by further sprinkling with oxidic pulverulent support substance.

The fineness of the oxidic pulverulent support substance to be applied to the surface of the core is matched to the desired shell thickness. For the preferred shell thickness range from 10 to 500 μm, pulverulent support substances of which 50% of the powder particles pass a sieve having a mesh opening of from 1 to 10 μm and whose proportion of particles having a longitudinal dimension greater than 50 μm is less than 1% are particularly suitable. In general, the distribution of the longitudinal dimension of the powder particles corresponds, due to the method of manufacture, to a Gauss distribution.

Suitable organic components of the liquid binder are, in particular, monohydric and polyhydric organic alcohols such as ethylene glycol, 1,4-butanediol, 1,6-hexanediol or glycerol, monobasic or polybasic organic carboxylic acids such as propionic acid, oxalic acid, malonic acid, glutaric acid or maleic acid, amino alcohols such as ethanolamine or diethanolamine, monofunctional or polyfunctional organic amides such as formamide, monosaccharides or oligosaccharides such as glucose, fructose, sucrose or lactose. The binder preferably consists of a solution containing from 20 to 90% by weight of water and from 10 to 80% by weight of an organic compound whose boiling point or sublimation temperature at atmospheric pressure is above 100° C. dissolved in water. The organic proportion of the liquid binder to be used is preferably from 10 to 50% by weight, particularly preferably from 20 to 30% by weight.

In the production of the coated catalyst, it is essential that the moistening with the binder is carried out in a controlled fashion. The surface of the core or previously formed shells is advantageously moistened to such an extent that liquid binder is present in adsorbed form in it but no liquid phase is visible on the surface. If the surface is too moist, the pulverulent support substance agglomerates to form separate agglomerates instead of becoming attached to the surface.

The catalytically active metal, which is selected from the group consisting of the metals of the 10th and 11th groups of the Periodic Table of the Elements, in particular platinum, palladium and silver, or a precursor compound of the metals, can be applied in various ways. In a preferred embodiment, the catalytically active metal or the precursor compound is dispersed in the pulverulent support substance. This can be achieved by firstly impregnating the pulverulent support substance with a solution of a compound of the catalytically active metal in a suitable solvent and subsequently, if necessary, evaporating the solvent. The catalytically active metal or the precursor compound is then applied together with the pulverulent support substance to the core of the coated catalyst during the coating procedure.

In another embodiment, the catalytically active metal or the precursor compound is dissolved or suspended in the binder. When building up the shell, the catalytically active metal or the precursor compound is then incorporated into the shell of the coated catalyst during spraying of the support with the binder.

In a further embodiment of the process, a solution or suspension of the catalytically active metal or the precursor compound is sprayed onto the support through a separate nozzle, which can be carried out during the formation of the shell or only after the shell has been built up.

After the shell has been built up, the volatile constituents are finally removed in a controlled fashion, e.g. by evaporation and/or sublimation. In the simplest case, this can be carried out by action of hot gases at an appropriate temperature (frequently from 50 to 150° C.). However, it is also possible for only predrying to be effected by the action of hot gases. Final drying can then be carried out, for example, in a drying oven of any type (e.g. a belt dryer). The temperature should be selected so that no significant change occurs in the porosity of the shell.

A particular advantage of the process of the present invention is that coated catalysts having two or more superposed shells of differing composition can be produced in one process step. The process of the present invention results in not only good adhesion of the successive layers to one another but also good adhesion of the lowermost layer to the surface of the core. This is also true in the case of annular cores.

In the process of the present invention, it is generally not necessary to employ a treatment at elevated temperature (calcination) so as to bond the particles of the pulverulent support substance by partial fusion. However, to increase the stability of the coated catalyst, it can be advantageous to calcine the coated catalyst at from 200 to 600° C. after vaporization of volatile constituents. The calcination is carried out at a comparatively low temperature.

The coated catalysts of the present invention display a very good selectivity in hydrogenation reactions. The coated catalysts of the present invention are therefore preferably used for the gas-phase hydrogenation of hydrocarbon fractions, preferably C₂-C₄ fractions.

The invention is illustrated by the examples below.

### EXAMPLES

### Example 1

### Production of a Comparative Catalyst

An aluminum oxide support in extrudate form having a BET surface area of 8 m²/g was impregnated by spraying at room temperature with an aqueous nitric acid solution of, based on the mass of support used, 0.045% by weight of silver in the form of silver nitrate and 0.025% by weight of palladium in the form of palladium nitrate. The volume of solution was 90% of the water uptake capacity of the support. The catalyst was dried at 80° C. and subsequently calcined at 400° C. Optical micrographs show the formation of an about 250-300 μm wide active component zone in the outer region of the extrudates.

### Example 2

### Catalyst 1 According to the Present Invention

A catalyst 1 according to the present invention was produced by coating 500 g of nonporous steatite spheres having a diameter of from 2.5 to 3 mm with 100 g of Versal® (aluminum oxide from La Roche, calcined for 5 hours at 1050° C., BET surface area: 40 m²/g) by parallel addition of a solution comprising adhesion promoter (glycerol) and, based on the amount of Versal used, 0.045% of silver used as silver nitrate and 0.0925% of palladium used as a nitric acid solution of palladium nitrate, drying and calcining at 300° C. Optical microscopy showed the thickness of the shell obtained to be a maximum of 200 μm.

### Example 3

### Catalyst 2 According to the Present Invention

A catalyst according to the present invention was produced by impregnating Versal® (calcined for 6 hours at 1100° C., BET surface area: 55 m²/g) with 0.045% of silver used as silver nitrate and 0.0925% of palladium used as a nitric acid solution of palladium nitrate, drying and calcining at 400° C. 500 g of nonporous steatite spheres having a diameter of from 2.5 to 3 mm were coated with 80 g of the silver- and palladium-impregnated Versal® with addition of an aqueous solution of adhesion promoter (glycerol), dried and calcined at 300° C.

The properties of the catalysts described in Examples 1 to 3 were tested in a laboratory apparatus at atmospheric pressure.

A premix of 99% by volume of ethylene and 1% by volume of acetylene was passed over 66 ml of the respective catalyst in a fixed-bed reactor, using a ratio of the hydrogen added to the premix to acetylene of 1.8:1 and a GHSV of 3000 l/h.

The following temperatures were required to obtain the respective selectivities to the desired product ethylene for 90% conversion of the acetylene:

| | | Selectivity to ethylene |
|---|---|---|
| Catalyst | Temperature [° C.] | [%] |
| Comparative catalyst | 69 | 25 |
| Catalyst 1 | 85 | 57 |
| Catalyst 2 | 100 | 61 |

The catalysts of the present invention display a significantly higher selectivity to the desired product ethylene compared to catalysts produced conventionally by impregnation owing to the defined active component profile.

We claim:

1. A coated catalyst having a core and at least one shell surrounding the core, wherein
the core is made up of an inert support material,
the shell or shells is/are made up of a porous support substance, with the shell being attached physically to the core, and at least one catalytically active metal selected from the group consisting of the metals of the 10th and 11th groups of the Periodic Table of the Elements, or a precursor of the catalytically active metal, is present in uniformly distributed, finely divided form in the shell or shells.

2. A coated catalyst as claimed in claim 1, wherein the support material of the core is porous and the total volume of the pores of the support material relative to the volume of the support material is ≦1% by volume.

3. A coated catalyst as claimed in claim 1 or 2, wherein the precursor of the catalytic metal is a metal oxide or a water-soluble metal salt, preferably a chloride, a nitrate, a C₁-C₁₀-carboxylate, a carbonate, a hydrogencarbonate, a sulfate, a hydrogensulfate or a phosphate.

4. A coated catalyst as claimed in any of claims 1, 2 and 3, wherein a plurality of superposed shells are provided, where the shells may comprise different catalytically active metals and/or the concentration of the catalytically active metal is different in adjacent shells.

5. A coated catalyst as claimed in any of claims 1 to 4, wherein the thickness of the shell is from 1 to 1000 μm, preferably from 10 to 500 μm in particular from 50 to 300 μm.

6. A process for producing a coated catalyst as claimed in any of claims 1 to 5, comprising the steps:
a) providing a support comprising an inert support material to form the core of the coated catalyst;
b) sprinkling the support with an oxidic, pulverulent support substance while keeping the support in motion, to form a shell;
c) spraying the support with a liquid binder comprising an aqueous solution of an organic compound which has a boiling point or sublimation point at atmospheric pressure of more than 100° C.;
d) introducing a catalytically active metal selected from the group consisting of the metals of the 10th and 11th groups of the Periodic Table of the Elements or a precursor compound of these metals;
e) evaporating volatile constituents;
f) if appropriate, activating the precursor compound, where steps b, c and d can be carried out simultaneously or in succession in any order and can also, if desired, be carried out two or more times.

7. A process as claimed in claim 6, wherein the catalytically active metal or the precursor compound is dispersed in the pulverulent support substance.

8. A process as claimed in claim 6, wherein the catalytically active metal or the precursor compound is dissolved or suspended in the binder.

9. A process as claimed in any of claims 6 to 8, wherein the support is firstly coated with a layer of dry pulverulent support substance and subsequently moistened with binder, and the shell is produced by sprinkling with dry pulverulent support material.

10. A process as claimed in any of claims 6 to 9, wherein the sprinkling of the support with pulverulent support material and the spraying of the support with binder are carried out simultaneously by means of physically separate feed lines.

11. A process as claimed in any of claims 6 to 10, wherein the first shell is applied to the support and a further shell which preferably has a composition different from that of the first shell is subsequently applied.

12. A process as claimed in any of claims 6 to 11, wherein the coated catalyst is calcined at from 200 to 600° C. after evaporation of volatile constituents.

13. The use of a coated catalyst as claimed in any of claims 1 to 5 for the reduction or purification of unsaturated hydrocarbons, preferably C₂-C₄ fractions.
